(19) United States
(12) Patent Application Publication
(10) Pub. No.: US 2019/0110109 A1
(43) Pub. Date: Apr. 11, 2019

(54) ELECTRONIC PROGRAM LISTING DISPLAYING HIGH DYNAMIC RANGE AND NON-HIGH DYNAMIC RANGE PROGRAM SELECTIONS

(71) Applicant: THOMSON Licensing, Issy-les-Moulineaux (FR)

(72) Inventors: Joel M. FOGELSON, Pasadena, CA (US); Arden A. ASH, Los Angeles, CA (US); Krystle SWAVING, LOS ANGELES, CA (US); Guillaume ANDRE ROGER GOUSSARD, Los Angeles, CA (US)

(73) Assignee: THOMSON Licensing, Issy-les-Moulineaux (FR)

(21) Appl. No.: 15/763,430

(22) PCT Filed: Sep. 29, 2015
(86) PCT No.: PCT/US15/52887

§ 371 Date: Mar. 26, 2018

(51) Int. Cl. H04N 21/482; H04N 5/445; H04N 21/431; H04N 5/57

(52) U.S. Cl. CPC H04N 21/4821; H04N 5/44543; H04N 2005/44556; H04N 5/57; H04N 21/4312

(57) ABSTRACT

The present principles generally relate to methods, systems and apparatus for electronic program listing processing and/or display (290). In particular, the present principles relate to providing an electronic program listing (295) or the like which is capable of indicating to viewers programs with high dynamic range (HDR) content differently than programs with non-high dynamic range content. In one exemplary embodiment, one or more program representations of an electronic program listing (295) representing one or more programs available in HDR format are displayed with higher brightness or luminance level than if the programs are available in non-HDR format. This way, a viewer is able to recognize easily and quickly which programs are HDR capable and which are not, just by glancing at the electronic program listing (295).

### TECHNICAL FIELD

The present principles generally relate to methods, systems and apparatus for electronic program listing processing and/or display. In particular, the present principles relate to providing an electronic program listing or the like which is capable of indicating to viewers programs with high dynamic range (HDR) content differently than programs with non-high dynamic range content. In one exemplary embodiment, one or more program representations of an electronic program listing representing one or more programs available in HDR format are displayed with higher brightness or luminance level than if the programs are available in non-HDR format. This way, a viewer is able to recognize easily and quickly which programs are HDR capable and which are not, just by glancing at the electronic program listing.

### BACKGROUND

A typical fluorescent light fixture has a luminance of approximately 2,000 nits (1 nit=1 candle/m²). The sun can illuminate objects to have luminance values up to 10,000 nits. A typical LCD display can display images to a maximum luminance of approximately 650 nits. Dynamic range is the ratio of intensity of the highest luminance parts of a scene and the lowest luminance parts of a scene. For example, the image projected by a video projection system may have a maximum dynamic range of 300:1.

The human visual system is capable of recognizing objects and features in images which have very high dynamic ranges. For example, a person can look into the shadows of an unlit flower on a brightly sunny day and observes details of objects in the shadows even though the luminance or brightness in adjacent sunlit areas may be thousands of times greater than the luminance in the shadow parts of the scene. To create a realistic rendering of such an image can require a display having a dynamic range in excess of 1000:1. The term “High Dynamic Range” (HDR) as used herewith indicates dynamic ranges of 800:1 or more, or that the format of the video content of a program has been designed as High Dynamic Range (HDR) by an industry or a well-known standard. As used herewith, the terms luminance and brightness are synonymous as well known in art.

Various types of display systems have been used to display HDR contents. For example, U.S. Pat. No. 8,482,698, titled “High Dynamic Range Display Using LED Backlight, Stacked Optical films, and LCD Drive Signal Based on a Low Resolution Light Field Simulation” issued to Atkins, and the article titled “Dynamic Backlight Gamma on High Dynamic Range LCD TVs”, Journal of Display Technology Vol. 4, No. 2 June 2008, pp. 139-146, Fang-Cheng Lin, et al., both describe a HDR display system which uses, for example, low resolution Light Emitting Diodes (LEDs) backlighting, in combination with a high resolution LCD front panel to achieve the capability of displaying HDR content. The backlighting LEDs are typically placed on a rear panel or formed as part of a rear array. The plurality of LED backlighting sources may be selectively modulated to enhance the brightness or the luminance of the backlighting of corresponding regions of the display. Accordingly, higher contrast and/or brightness may be provided for HDR content. Alternatively, it is also known to use organic light emitting diodes (OLEDs) or quantum dots, instead of LEDs to provide the backlighting.

In addition, U.S. Pat. No. 7,377,652, titled “HDR Display having Location Specific Modulation”, issued to Whitehead also describes a HDR system. The Whitehead system is a projection-based HDR system for providing displaying of HDR content on a projection screen. The screen in Whitehead may be a front projection screen or a rear projection screen.

Furthermore, electronic devices such as televisions, set top boxes, personal computers (PC), tablets, cellphones, and etc., require a control system that includes a user interface system. Typically, a user interface system provides information to and receives information from a user, and enables the usage of the device. One example of a user interface system is an electronic program listing and its associated user interaction menu in an electronic device.

An electronic program listing may comprise a program or media asset information listing, related information database, and/or an interactive user interface. An electronic program listing obtains metadata including program information about program contents from an information provider (which may differ from the program content provider) and may display the program information to a user. As used herewith, metadata are defined as data that describe other data, as is well known in the art. In the example of an electronic program listing, metadata are data which describe, for example, program content. The program content may be a video and/or an audio media asset from various sources, such as, for example, broadcast, satellite, internet, local storage media, and etc. Program listing metadata information typically comprises programming information for a program such as, for example, program format (such as e.g., high-definition or low definition), channel number, program title, start time, end time, elapsed time, time remaining, review rating, parental guide rating, genre, a description of the program's content, and, etc. Also, metadata may also include graphical representations comprising one or more or texts and/or images representing the plurality of the programs on the program listing. These graphical representations may be hypertext-linked, as is well known in the art.

For example, FIG. 1A shows a known program listing 100 which is used by a media content provider MGO on its website www.mgo.com. As shown in FIG. 1A, the electronic program listing 100 provides a list of visual representations of newly released media assets available to a user for viewing and/or downloading. The electronic program listing 100 displays a plurality of graphical representations representing the different programs selectable by the user. The graphical representations may comprise hypertext linked images and/or texts which will lead to other menu choices or device actions (e.g., playing of the video), if they are selected by the viewer.

FIG. 1B illustrates another exemplary electronic program listing in a representation of an electronic program guide (EPG) 105 in a grid format, as well known in the art. The “grid guide” 105 has a plurality of grids in the central portion of the guide 105. Each grid in the central portion of the EPG 105 may represent a selectable program. By looking at the horizontal and vertical axes of the program guide 105, a viewer may easily determine what time a particular program will be shown and on which channel. In addition, as illustrated in FIG. 1C, a viewer may highlight and select one of the grids in a grid program guide 110 for viewing or to obtain further information about the selected program. For example, FIG. 1C shows what happens when a viewer has highlighted and selected the movie ZULU 130 in order to obtain further information about the program. In response, EPG 110 in FIG. 1C displays additional program guide information for the movie ZULU as shown in information panel 135. The additional program guide information may include, e.g., detailed information about actors, producers, ratings, and etc., of the movie ZULU as shown in panel 135 of FIG. 1C.

Also, U.S. Pat. No. 6,111,611, issued to Ozkan et al., describes in detail an exemplary embodiment of a system for providing program listing metadata information to an electronic device including data packet structure for carrying the program listing information from a provider to the electronic device. The exemplary data packet structure is designed so that both the channel information (e.g., channel name, call letters, channel number, type, etc.) and the program description information (e.g., content format, title, rating, star, genre, etc.) relating to a program may be transmitted from a program listing database provider to a receiving and/or processing apparatus.

### BRIEF SUMMARY OF THE DRAWINGS

The features and advantages of the present principles may be apparent from the detailed description below when taken in conjunction with the figures described below:

FIGS. 1A-1C show examples of existing electronic program listings.

FIG. 2 shows an exemplary system including an exemplary apparatus according to the present principles.

FIG. 3 shows an exemplary process according to the present principles.

FIG. 4 shows an exemplary electronic program listing according to the present principles.

FIG. 5 shows another exemplary electronic program listing according to the present principles.

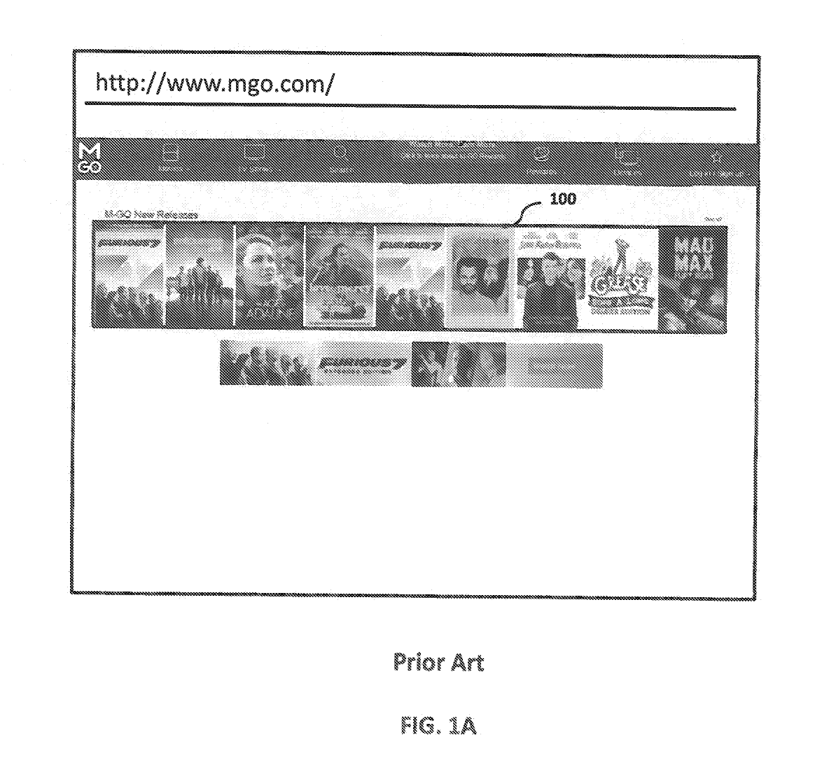

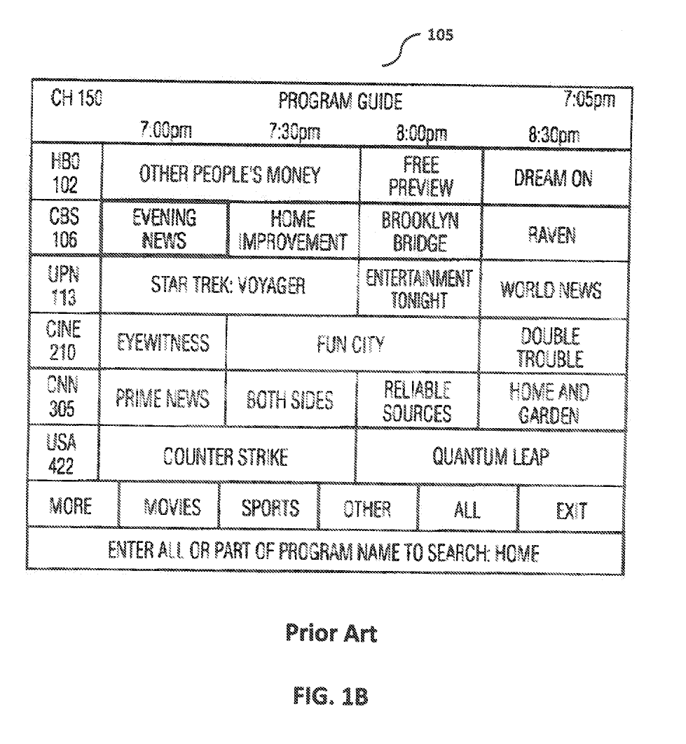

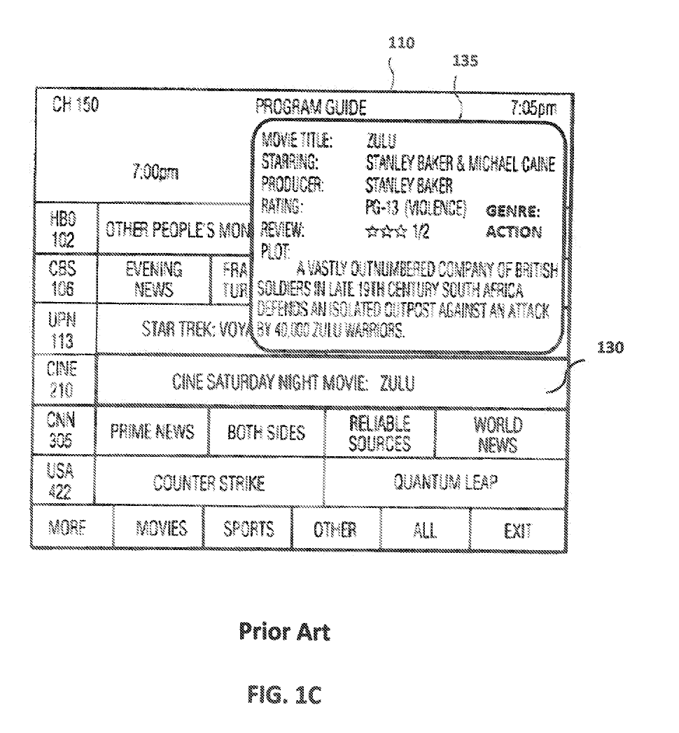

### SUMMARY OF PRESENT PRINCIPLES

Accordingly, the present principles provide an apparatus, comprising: a communication interface configured to receive metadata associated with a program of video data, said metadata indicating whether content of the program is one of HDR format or non-HDR format; and a processor configured to change a level of brightness of a display region associated with the program of an electronic program listing displayed on an HDR video display in response to the metadata indicating the content of the program is HDR format by adjusting selected one or more of a plurality of light emitting sources of the HDR video display, wherein the level of brightness is adjusted to be brighter on the program listing for the program which is in HDR format compared with a program which is not in HDR format.

The present principles further provide a method comprising: receiving, via a communication interface, metadata associated with a program of video data, said metadata indicating whether content of the program is one of HDR format or non-HDR format; and changing, via a processor, a level of brightness of a display region associated with the program of an electronic program listing displayed on an HDR video display in response to the metadata indicating the content of the program is HDR format by adjusting selected one or more of a plurality of light emitting sources of the HDR video display, wherein the level of brightness is adjusted to be brighter on the program listing for the program which is in HDR format compared with a program which is not in HDR format.

The present principles further provide a computer program product stored in non-transitory computer-readable storage media comprising computer-executable instructions for: receiving, via a communication interface, metadata associated with a program of video data, said metadata indicating whether content of the program is one of HDR format or non-HDR format; and changing, via a processor, a level of brightness of a display region associated with the program of an electronic program listing displayed on an HDR video display in response to the metadata indicating the content of the program is HDR format by adjusting selected one or more of a plurality of light emitting sources of the HDR video display, wherein the level of brightness is adjusted to be brighter on the program listing for the program which is in HDR format compared with a program which is not in HDR format.

### DETAILED DESCRIPTION

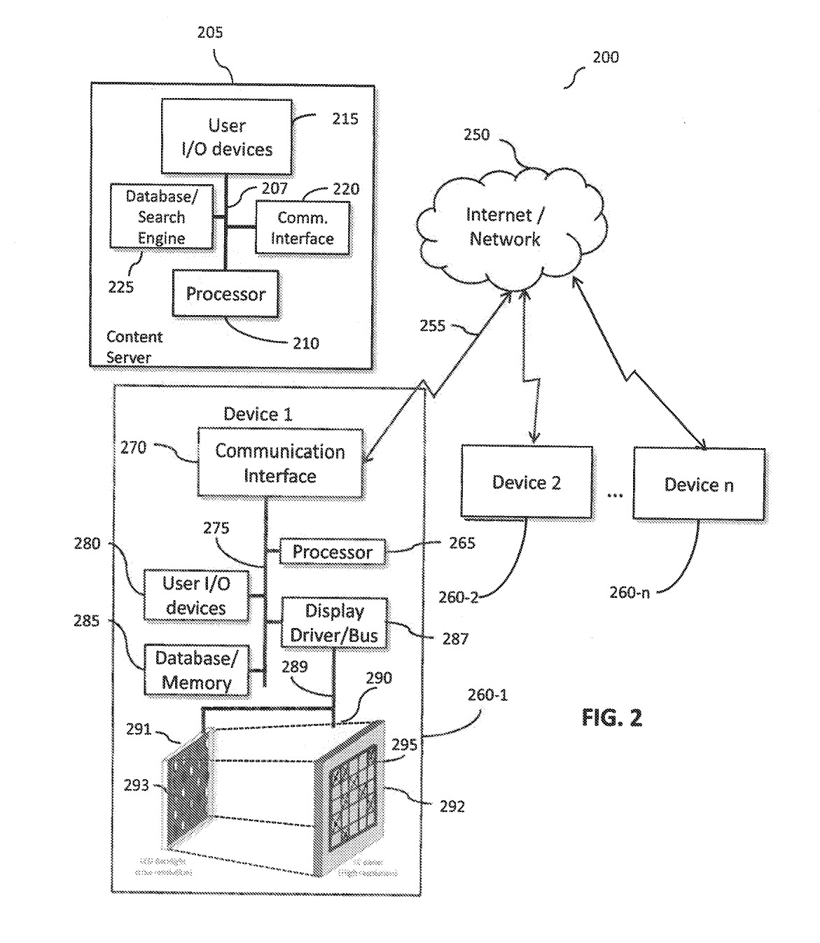

FIGS. 2-5 illustrate various exemplary embodiments according to the present principles. The functions of the various elements shown in the figures may be provided through the use of dedicated hardware as well as hardware capable of executing software in association with appropriate software. When provided by a processor, the functions described herewith may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include implementations such as, without limitation, digital signal processor (“DSP”) hardware, Programmable Logic Array (PLA), Application Specific Integrated Circuit (ASIC), read-only memory (“ROM”) for storing software, random access memory (“RAM”), non-volatile storage, or the like.

Also, although each of the components in the drawings is shown as an individual block, each individual block may further represent, e.g., one or more combinations of circuitries such as, e.g., one or more integrated circuits (ICs), one or more circuit boards, or one integrated circuit (IC) with one or more circuitries embedded on the same IC die, as well known in the art. For example, a communication interface block 207 shown in FIG. 2 may represent one or more integrated circuits or circuit boards having a combination of different communication capabilities such as, e.g., Ethernet, Wi-Fi, cellphone, cable, satellite, and/or terrestrial TV communication, etc., as to be described in more detail below.

As noted above, in order to provide better viewing experience for users, HDR contents have become more desirable. Recently, H.265/HEVC standard extensions (H.265/HEVC version 2) have been approved by ISO/IEC and ITU-T Joint Collaborative Team on Video Coding (JCT-VC) to provide for compression and signaling of HDR video contents. The H.265/HEVC standard provides for 10- or 12-bit of encoding for each pixel component value and therefore allows the expansion of the dynamic range of a video program to achieve High Dynamic Range (HDR). Also, the H.265/HEVC standard specifies certain metadata messages, called Supplemental Enhancement Messages for signaling of HDR contents. Specifically, HEVC version 2 includes three SEI messages related to HDR data: Chroma resampling filter hint SEI message, Knee function information SEI message, and Mastering display color volume SEI message. Accordingly, HDR video program contents may be encoded, signaled and transmitted in compliance with H.265/HEVC standard.

The present invention recognizes that not all of the program contents may be encoded and transmitted in HDR format due to a variety of factors, such as cost, transmission bandwidth, original content format, and etc. Therefore, it is desirable to be able to provide apparatus and methods for viewers to recognize easily and quickly which programs are HDR programs and which are not, by simply looking at an electronic program listing.

FIG. 2 shows an exemplary system according to the present principles. For example, a system 200 in FIG. 2 includes a content server 205 which is capable of receiving and processing user requests from one or more of user devices 260-1 to 260-n. The content server 205, in response, provides programs comprising various media assets such as movies or TV shows for transporting, viewing, streaming or downloading.

In particular, various user devices 260-1 to 260-n in FIG. 2 may communicate with the exemplary server 205 over a communication network 250 such as the internet, a wide area network (WAN), and/or a local area network (LAN). Server 205 may communicate with user devices 260-1 to 260-n in order to provide relevant information such as metadata, web pages, media contents, and etc. to user devices 260-1 to 260-n. Server 205 may also provide additional processing of information when the processing is not available and/or capable of being conducted on the local user devices 260-1 to 260-n. As an example, server 205 may be a computer having a processor 210 such as, e.g., an Intel processor, running an appropriate operating system such as, e.g., Windows 2008 R2, Windows Server 2012 R2, Linux operating system, and etc. In addition, processor 210 controls the various functions and components of the server 205 via a control bus 207 as shown in FIG. 2.

User devices 260-1 to 260-n may access different media assets, web pages, services or databases provided by server 205 using, e.g., HTTP protocol. A well-known web server software application which may be run by server 205 to provide web pages is Apache HTTP Server software available from http://www.apache.org.

Likewise, examples of well-known media server software applications include Adobe Media Server and Apple HTTP Live Streaming (HLS) Server. Using media server software as mentioned above and/or other open or proprietary server software, server 205 may provide media content services similar to, e.g., Amazon.com, Netflix, or M-GO. Server 205 may use a streaming protocol such as e.g., Apple HTTP Live Streaming (HLS) protocol, Adobe Real-Time Messaging Protocol (RTMP), Microsoft Silverlight Smooth Streaming Transport Protocol, and etc., to transmit various programs comprising media assets such as, e.g., video programs, audio programs, movies, TV shows, software, games, electronic books, electronic magazines, electronic articles, and etc., to an end-user device 260-1 for purchase and/or viewing via streaming, downloading, receiving or the like.

In addition, a server administrator may interact with and configure server 205 to run different applications using user input/output (I/O) devices 215 (e.g., a keyboard and/or a display) as well known in the art. Furthermore, various web pages, data, media assets and their associated metadata may be stored in a database 225 and accessed by processor 210 as needed. Database 225 may reside in appropriate non-transitory storage media, such as, e.g., one or more hard drives and/or other suitable memory devices, as well known in the art. Similarly, computer program products for the server 205 may also be stored in such non-transitory storage media. Also, element 225 of server 205 may also represent a search engine so that media recommendations may be made, e.g., in response to a user's profile of consumption and/or purchases of media assets, and/or criteria that a user specifies using textual input (e.g., entering “sports”, “adventure”, “Tom Cruise”, and etc.).

In addition, server 205 is connected to network 250 through a communication interface 220 for communicating with other servers or web sites (not shown) and to one or more user devices 260-1 to 260-n, as shown in FIG. 2. The communication interface 220 may also represent television signal modulator and RF transmitter in the case of when the content provider 205 represents a television station, cable or satellite television provider. In addition, one skilled in the art would readily appreciate that other server components, such as, e.g., ROM, RAM, power supply, cooling fans, etc., may also be needed, but are not shown in FIG. 2 to simplify the drawing.

User devices 260-1 to 260-n shown in FIG. 2 may be one or more of, e.g., a PC, a laptop, a tablet, a cellphone, a video receiver, and etc. One of such devices may be, e.g., a Microsoft Windows 10 computer/tablet, an Android phone/tablet, an Apple IOS phone/tablet, or a television receiver or the like. A detailed block diagram of an exemplary user device according to the present principles is illustrated in block 260-1 of FIG. 2 as Device 1.

An exemplary user device 260-1 in FIG. 2 comprises a processor 265 for processing various data and for controlling various functions and components of the device 260-1, including video decoding and processing to play and display a received program content. The processor 265 communicates with and controls the various functions and components of the device 260-1 via a control bus 275 as shown in FIG. 2.

In additional, device 260-1 also comprises user input/output (I/O) devices 280 which may comprise, e.g., a touch and/or a physical keyboard for inputting user data, and/or a speaker, and/or indicator lights, for outputting visual and/or audio user data and feedback. Device 260-1 also comprises a memory 285 which may represent both a transitory memory such as RAM, and a non-transitory memory such as a ROM, a hard drive or a flash memory, for processing and storing different files and information as necessary, including computer program products, webpages, user interface information, metadata including electronic program listing information and database and etc., as needed. Device 260-1 also comprises a communication interface 270 for connecting and communicating to/from server 205 and/or other devices, via, e.g., network 250 using e.g., a connection through a cable network, a FIOS network, a Wi-Fi network, and/or a cellphone network (e.g., 3G, 4G, LTE), and etc.

According to the present principles, device 260-1 may represent an exemplary electronic device which is capable of processing and displaying HDR contents, similar to those described in e.g., U.S. Pat. No. 8,482,698 and the Lin article mentioned previously. In particular, as shown in FIG. 2, a HDR display 290 is provided in device 260-1 which may comprise a front display panel 292 and a plurality of light emitting sources 293 at the rear of the front display panel 292. The plurality of light emitting sources may be ones of light emitting diodes, organic light emitting diodes, or quantum dots. Although the exemplary display panel is shown as part of device 260-1 in FIG. 2 for illustration purposes, one skilled in the art may readily recognize that the display may also be provided as an external display, separate from the rest of the device 260-1.

In one exemplary embodiment as shown in FIG. 2, the HDR display 290 is a dual-panel display, with a front panel 292 being a LCD panel, and a back panel 291 comprising the plurality of light emitting sources 293 made out of, e.g., LEDs. In addition, each light source or element on the back panel 291 may be individually driven, control and/or modulated by a display driver/bus component 287 under the control of processor 265 via a display bus 289 as shown in FIG. 2 to provide backlighting for the HDR video display 290. Therefore, the level of luminance or brightness for each region of the front display 292 may be increased or decreased by controlling of the plurality of rear light sources 293. For example, FIG. 2 shows a program listing 295 being displayed on the front panel 292, where the regions with dashed X's represent regions where the brightness has been increased relatively to the other regions of the program listing 295. This is achieved either by the increased illumination of the selected plurality of lighting sources on the back panel 291 corresponding to the dashed X regions, or the decreased of the other non-selected light sources on the back panel 291 corresponding to the non-dashed X regions. In a non-limiting embodiment, the front panel 292 has a higher resolution than that of the back panel 291.

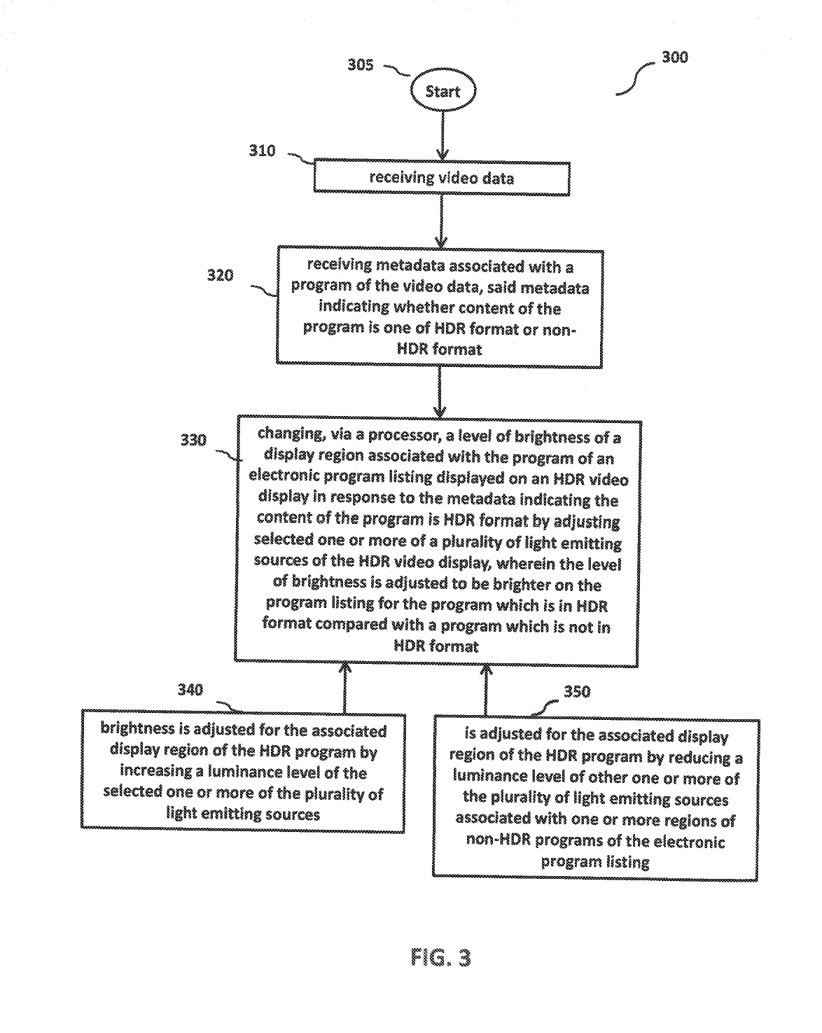

FIG. 3 represents a flow diagram of an exemplary process 300 according to the present principles. Process 300 may be implemented as a computer program product comprising computer executable instructions which may be executed by e.g., processor 265 of device 260-1 of FIG. 2. The computer program product having the computer-executable instructions may be stored in a non-transitory computer-readable storage media as represented by e.g., memory 285 of FIG. 2. One skilled in the art can readily recognize that the exemplary process shown in FIG. 3 may also be implemented using a combination of hardware and software (e.g., a firmware implementation), and/or executed using PLA or ASIC, etc., as already mentioned above.

At 310 of FIG. 3, video data are received via, e.g., a communication interface 270 of an electronic device 260-1 of FIG. 2. At 320 of FIG. 3, metadata associated with a program of the video data are also received by, e.g., electronic device 260-1 of FIG. 2. The metadata may also be received through the same or different communication interface as that of the video data. The metadata may come from the same source as the provider of the video data or through another source. That is, for example, the video source may be provided via the content server 205 of FIG. 2, but the metadata associated with the video data may be provided, e.g., by another website, server, television provider, and/or through a different network and/or transmission medium.

Metadata, according to the present principles, indicate whether content of a program in the video data is one of HDR format or non-HDR format. That is, the metadata would indicate whether the corresponding program in the video data stream is capable of being displayed in HDR format, and/or designated as such by either the content provider or the metadata provider. Also, the metadata may be received, e.g., as part of the program listing information as described above, or as part of an industry standard format or another proprietary format. That is, for example, the metadata may be, e.g., just 1 bit of the program listing information being received with “1” indicating that the content of the corresponding program is in HDR format, and “0” indicating that the corresponding program is not in HDR format. Alternatively, the metadata may be, e.g., one or more the HDR SEI messages provided by H.265/HEV standard. As already mentioned above, the content of the HDR program may be encoded by H.265/HEV standard or any other format, either compliant with industry standard or a proprietary standard.

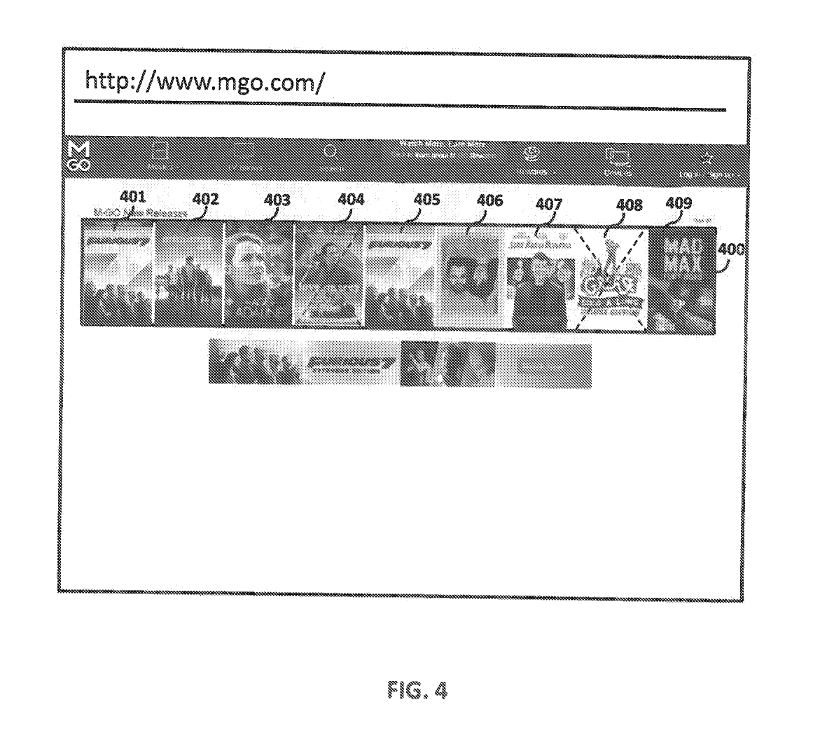

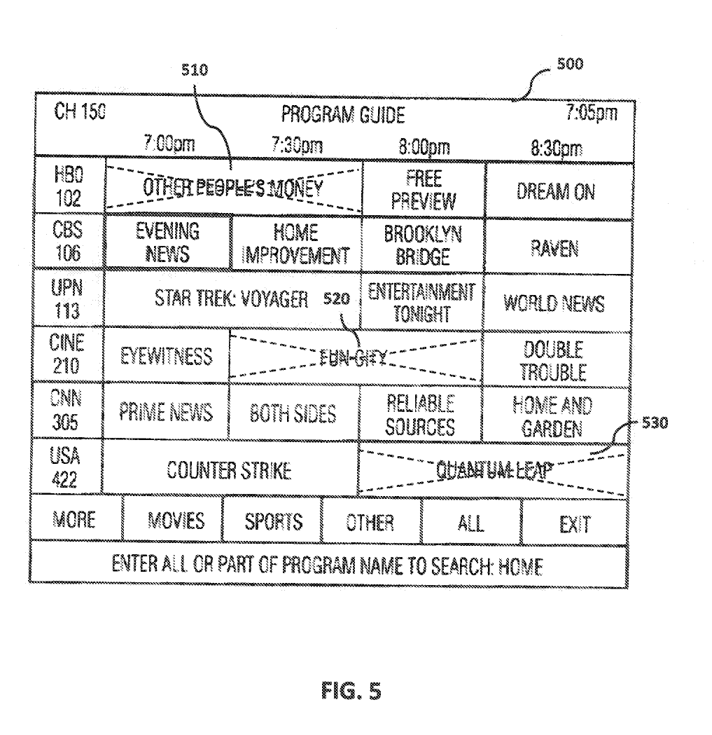

At 330 of FIG. 3, a level of brightness of a display region associated with the program of an electronic program listing being displayed on an HDR video display is changed accordingly. This brightness change is in response to the metadata indicating that the content of the program is in HDR format as described above. This change is made by adjusting the selected one or more of a plurality of light emitting sources of the HDR video display 290 as shown in device 260-1 of FIG. 2. The light emitting sources may be, for example, the plurality of light sources 293 of FIG. 2 as described above. The level of brightness is adjusted to be brighter on the electronic program listing for programs designated by the metadata as having HDR format compared with that of programs not designated by the metadata as having HDR format. Therefore, a viewer may easily and quickly recognize which programs are HDR programs and which are not, by simply looking at the electronic program listing such as an exemplary program listing 295 of device 260-1 in FIG. 2 as described above, or an exemplary program listing 400 shown in FIG. 4 and an exemplary program listing 500 shown in FIG. 5 to be described later.

At 340, according to the present principles, brightness or luminance level is adjusted for the associated display region of the HDR program by increasing a luminance level of the selected one or more of the plurality of light emitting sources responsible for illuminating the associated display region. That is, e.g., processor 265 of device 260-1 of FIG. 2 causes or commands display drive/bus 287 to drive corresponding light sources 293 so that one or more corresponding regions of HDR programs are provided with enhanced brightness or luminance compared with other regions of non-HDR programs, as shown on program listing 295 and as described above.

At 350, as an alternative to 340 above of boosting the brightness of the HDR-program region of the display, the appearance of relative luminance levels of HDR vs. non-HDR programs may be provided by reducing the brightness levels of the non-HDR program regions. Therefore, the same result of allowing a viewer to quickly find HDR programs with enhanced brightness in an electronic display is also achieved.

Hence, according to the present principles, FIG. 4 shows an exemplary electronic program listing 400 which has the luminance or brightness level of the graphical representations of two HDR programs 404 and 408 enhanced, relative to the other non-HDR programs 401-403, 405-407, and 409 on the program listing 400. The higher level of brightness is indicated in FIG. 4 as dashed X's on the program representations. Likewise, FIG. 5 shows three programs 510, 520 and 530 having the brightness level of their respective regions on the program listing 500 relatively increased (or the other regions of the EPG 500 relatively decreased), in order to provide easy recognition of HDR contents in a program listing according to the present principles.

Numerous specific details have been set forth herein to provide a thorough understanding of the present principles. It will be understood by those skilled in the art, however, that the examples above may be practiced without these specific details. In other instances, well-known operations, components and circuits have not been described in detail so as not to obscure the present principles. It can be appreciated that the specific structural and functional details disclosed herein may be representative and do not necessarily limit the scope of the present principles.

Various examples of the present principles may be implemented using hardware elements, software elements, or a combination of both. Some examples may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

1. A method performed by a receiver, comprising:
receiving, via a communication interface, metadata associated with a program of video data, said metadata indicating whether content of said program is one of HDR format and non-HDR format; and
changing, via a processor, a level of brightness of a display region associated with said program of an electronic program listing displayed on an HDR video display in response to said metadata indicating said content of said program is HDR format by adjusting selected one or more of a plurality of light emitting sources of said HDR video display, wherein said level of brightness is adjusted to be brighter on said program listing for said program which is in HDR format compared with a program which is not in HDR format.

2. The method of claim 1 wherein said HDR video display is a dual-panel display.

3. The method of claim 1 wherein said HDR video display comprises a front panel and said plurality of light emitting sources being positioned in rear of said front panel.

4. The method of claim 3 wherein said plurality of light emitting sources comprising at least ones of light emitting diodes (LEDs), organic light emitting diodes, and quantum dots.

5. The method of claim 4 wherein said front panel is an LCD panel.

6. The method of claim 3 wherein said plurality of light emitting sources are light emitting diodes (LEDs), and said light emitting diodes are positioned on a rear backlight panel and said LCD front panel has a higher resolution than said rear LED backlight panel.

7. The method of claim 3 wherein said brightness is adjusted for said associated display region of said program in HDR format by increasing a luminance level of said selected one or more of the plurality of light emitting sources.

8. The method of claim 3 wherein said brightness is adjusted for said associated display region of said program in HDR format by reducing a luminance level of other one or more of said plurality of light emitting sources associated with one or more regions of non-HDR programs of said electronic program listing.

9. The method of claim 1 wherein said electronic program listing is an electronic program grid guide.

10. The method of claim 1 wherein said electronic program listing displays a plurality of graphical representations representing a plurality of programs.

11. An apparatus comprising:
a communication interface configured to receive metadata associated with a program of video data, said metadata indicating whether content of said program is one of HDR format and non-HDR format; and
a processor configured to change a level of brightness of a display region associated with said program of an electronic program listing displayed on an HDR video display in response to said metadata indicating said content of said program is HDR format by adjusting selected one or more of a plurality of light emitting sources of said HDR video display, wherein said level of brightness is adjusted to be brighter on said program listing for said program which is in HDR format compared with a program which is not in HDR format.

12. The apparatus of claim 12 wherein said HDR video display is a dual-panel display.

13. The apparatus of claim 12 wherein said HDR video display comprises a front panel and said plurality of light emitting sources being positioned in rear of said front panel.

14. The apparatus of claim 13 wherein said plurality of light emitting sources comprising at least ones of light emitting diodes (LEDs), organic light emitting diodes, and quantum dots.

15. The apparatus of claim 14 wherein said front panel is an LCD panel.

16. The apparatus of claim 13 wherein said plurality of light emitting sources are light emitting diodes (LEDs), and said light emitting diodes are positioned on a rear backlight panel and said LCD front panel has a higher resolution than said rear LED backlight panel.

17. The apparatus of claim 13 wherein said brightness is adjusted for said associated display region of said program in HDR program by increasing a luminance level of said selected one or more of said plurality of light emitting sources.

18. The apparatus of claim 13 wherein said brightness is adjusted for said associated display region of said program in HDR format by reducing a luminance level of other one or more of said plurality of light emitting sources associated with one or more regions of non-HDR programs on said electronic program listing.

19. The apparatus of claim 11 wherein said electronic program listing is an electronic program grid guide.

20. The apparatus of claim 11 wherein said electronic program listing displays a plurality of graphical representations representing a plurality of programs.

21. A computer program product stored in non-transitory computer-readable storage media, comprising computer-executable instructions for:
receiving, via a communication interface, metadata associated with a program of video data, said metadata indicating whether content of said program is one of HDR format and non-HDR format; and
changing, via a processor, a level of brightness of a display region associated with said program of an electronic program listing displayed on an HDR video display in response to said metadata indicating said content of said program is HDR format by adjusting selected one or more of a plurality of light emitting sources of said HDR video display, wherein said level of brightness is adjusted to be brighter on said program listing for said program which is in HDR format compared with a program which is not in HDR format.
